(19) United States
(12) Patent Application Publication
(10) Pub. No.: US 2016/0347631 A1
(43) Pub. Date: Dec. 1, 2016

(54) TANNIN-BASED POLYMER AS FILTER AID FOR REDUCING FOULING IN FILTRATION OF HIGH TDS WATER

(71) Applicant: GENERAL ELECTRIC COMPANY, Schenectady, NY (US)

(72) Inventors: Hongchen DONG, Schenectady, NY (US); Jason Louis DAVIS, Albany, NY (US); Stephen Robert VASCONCELLOS, Doylestown, PA (US); Michael Brian SALERNO, Huntingdon Valley, PA (US); Jason NICHOLS, Niskayuna, NY (US)

(21) Appl. No.: 15/033,628

(22) PCT Filed: Mar. 28, 2014
(86) PCT No.: PCT/US2014/032183

§ 371 Date: Apr. 30, 2016

(30) Foreign Application Priority Data
Jun. 27, 2013 (US) PCT/US2013/048153

(51) Int. Cl. C02F 1/56; B01D 61/16; C02F 1/66; B01D 61/14; C02F 1/52; C02F 1/44

(52) U.S. Cl. CPC C02F 1/56; C02F 1/5272; C02F 1/444; C02F 1/5236; C02F 1/66; B01D 61/145; B01D 61/147; B01D 61/16; B01D 2325/02; C02F 2001/007

(57) ABSTRACT

The present invention concerns a method of reducing fouling and increasing the efficiency of microfiltration and ultrafiltration systems by adding an effective amount of a tannin-based polymer to wastewater containing high concentrations of total dissolved solids (TDS), such as produced water, prior to filtration. Additional pretreatment to separate out and remove coagulated solids before filtration is not required. Typically, the tannin polymer used in treating the process water is a modified tannin comprised of a Mannich reaction product of an amine, an aldehyde, and a tannin.

### CROSS REFERENCE TO RELATED APPLICATION

This application is a national stage application under 35 U.S.C. §371(c) of prior filed, PCT application serial number PCT/US2014/032183, filed on Mar. 28, 2014, which claims priority to International Application No. PCT/US13/48153 filed on Jun. 27, 2013. The above-listed applications are herein incorporated by reference.

### FIELD OF THE INVENTION

Embodiments of the present invention are related to a method of treating and filtering wastewater obtained from oil and gas recovery, production or refining operations. More particularly, aspects of the invention relate to a process for reducing fouling, increasing recovery and increasing flux during low-pressure filtration of produced water with high concentrations of total dissolved solids (TDS) by adding an effective amount of a tannin-based polymer prior to filtration.

### BACKGROUND

Produced water is the aqueous liquid phase that is co-produced along with the oil and/or gas phases during an oil and gas operation. This oily wastewater has become the largest volume waste stream in the exploration, recovery and production process of oil and gas. Roughly three barrels of produced water are produced per barrel of recovered oil, resulting in more than 40 billion USD for treatment and disposal cost to the oil and gas industry. Recovery and reuse of these wastewaters from hydrocarbon operations are needed to reduce operational costs and to minimize environmental concerns, especially in oil and gas production wells located in water-scarce regions. For purposes of this disclosure, produced water includes any wastewater associated with traditional oil and gas extraction, refining and production operations, as well as the water associated with hydraulic fracturing operations (frac water) and brines.

Although produced water can be recycled, it must first be clarified and separated from substantial amounts of oil and grease (O&G) (characterized as emulsified or suspended oil, dispersed oil, dissolved oil, or free oil) and other suspended particulates. Produced water may also contain high levels of total dissolved solids (TDS); dissolved and volatile organic compounds; heavy metals; dissolved gases; bioorganisms and bacteria; and other impurities and additives. Produced water varies greatly in quality and quantity depending on the location and characteristics of the oil and gas operation. Furthermore, the amount of produced water, the contaminants and their concentrations varies significantly over the lifetime of any particular well.

The use of low-pressure membrane filtration-microfiltration (MF) and ultrafiltration (UF) has been considered to remove suspended particles, turbidity, microorganisms and some viruses from wastewater. Compared to conventional treatment processes such as sedimentation and rapid filtration, MF and UF have improved reliability, relative simplicity of installation and smaller footprint to meet stricter regulation for finished water quality. One of the major concerns in MF or UF is membrane fouling due to internal pore plugging by fine particulates. Pore plugging increases membrane resistance and decreases membrane flux, and correspondingly increases cost of operation. While traditional membrane fouling control approaches mostly reply on optimization of hydrodynamics, backwashing, air sourcing and chemical cleaning, attempts have been made to add chemicals to the mixed water and enhance the filterability of membranes. These filterability improvement chemicals serve to coagulate and flocculate the suspended particles and thereby to bind colloids and other mixed liquor components in flocs. Options include use of inorganic coagulants and water soluble polymers. For example, U.S. Pat. No. 6,428,705 claims coagulant-assisted low-pressure microfiltration for high flow and low pressure impurity removal. Various patents disclose the use of water-soluble polymers in membrane bioreactors (MBR) for flux enhancement, including U.S. Pat. Nos. 6,723,245, 6,872,312, 6,926,832, 7,611,632, 7,378,023, U.S. Patent Application Publication No. 2004/0168980, 2006/0272198, 2012/0255903 and 2013/0048563.

Despite use of inorganic coagulants and water soluble polymers to enhance the filterability of low pressure MF and UF membranes, membrane fouling is still a concern due to internal pore plugging by fine particulates when treating and filtering produced water from oil and gas operations. This is because waters being treated from oil and gas operations, e.g. produced water, typically contain high total dissolved solids (TDS) levels, i.e. greater than about 5000 ppm (mg/L) and up to about 460,000 ppm (mg/L). Membrane fouling in turn increases membrane resistance and decreases membrane flux, thereby increasing the cost of treating produced waters. Current methods and applications do not address the mitigation of membrane fouling in UF or MF applications under high TDS stress conditions.

It therefore is an object of the present invention to provide a novel process for enhancing the filterability of MF and UF membranes when treating produced waters from oil and gas operations by first adding to the produced water an enhancement chemical that is not affected by a high TDS level, e.g. TDS levels greater than about 5,000 ppm and up to about 460,000 ppm. More specifically, the use of tannin-based polymer(s) in combination with low pressure microfiltration or ultrafiltration are disclosed, wherein the tannin-based polymers mitigate fouling and increase membrane throughput (or flux) under high TDS stress condition. It also reduces the frequency and duration of the membrane cleaning and replacement, reduces the footprint and simplifies the treatment of produced waters, but eliminating a pretreatment, solid removals step. By practicing the methods disclosed herein, increased efficiency and effectiveness of low pressure filtration systems for high TDS produced waters is observed.

### SUMMARY OF THE INVENTION

Embodiments of the present invention concern a method of reducing fouling on the surface of filtration media, and increasing recovery and throughput (flux) of low-pressure filtration systems, for raw wastewater containing high levels of TDS. According to one embodiment of the invention, a tannin-based polymer is used as a coagulant to treat raw wastewater prior to low pressure filtration in a water treatment system, resulting in reduced fouling, increased flux, increased permeability, increased recovery in the of the low pressure microfiltration system.

In accordance with one aspect of the invention, a method is provided for reducing fouling and increasing the flux and recovery of low pressure filtration systems for wastewater containing suspended solids, the wastewater having a high total dissolved solids (TDS) concentration, comprising the steps of providing wastewater having a TDS content greater than about 5,000 ppm; treating the wastewater with an effective amount of at least one modified tannin effective to flocculate solids suspended in the wastewater, wherein the modified tannin is produced by reacting a condensed tannin with an amino compound and an aldehyde; producing flocculated solids and treated water with reduced turbidity; and passing the treated water through a low pressure filtration medium to remove flocculated solids suspended from the treated water.

In accordance with still other embodiments, a method for reducing the fouling of low pressure filtration systems is provided comprising the steps of: a) drawing influent wastewater from a source, wherein the wastewater contains suspended solids and has a total dissolved solids content greater than about 5,000 ppm; b) placing the influent wastewater into a holding tank, pond, or vessel; c) adding an effective amount of a tannin amine polymer to the influent wastewater to produce treated wastewater and flocculated solids; and d) directing a stream of treated wastewater from the holding tank, pond, or vessel to a low pressure filtration system.

The low pressure filtration step or system may be ultrafiltration or microfiltration. The tannin-based polymer is comprised of a Mannich reaction product of an amine, an aldehyde, and a tannin. The amine, aldehyde, and tannin can be combined simultaneously, or in different orders. Additionally, in certain embodiments, a cationic and/or anionic flocculant can be added to treat the wastewater.

It is an object of this invention to provide a pretreatment filter aid, or chemical additive, which may be used with produced waters containing substantial concentrations of total dissolved solids to efficiently clarify and filter such water using microfiltration or ultrafiltration, without the need for a separate pretreatment step to separate and remove the coagulated solids.

The present invention and its advantages over the prior art will become apparent upon reading the following detailed description and the appended claims.

### BRIEF DESCRIPTION OF THE DRAWINGS

These and other aspects of the invention will be understood from the description and claims herein, taken together with the drawings showing details of construction and illustrative embodiments, wherein:

FIG. 1 is a schematic representation of one process in accordance with one embodiment of the invention.

FIG. 2 is a graphical representation of data found in Table 3.

FIG. 3 is a graphical representation of data found in Table 3.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges stated herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises”, “comprising”, “includes”, “including”, “has”, “having”, or any other variation thereof, are intended to cover a non-exclusive inclusion. For example, a process, method, article or apparatus that comprises a list of elements is not necessarily limited to only those elements, but may include other elements not expressly listed or inherent to such process, method, article, or apparatus.

The singular forms “a”, “an”, and “the” include plural referents unless the context clearly dictates otherwise.

Coagulants are used to clarify industrial waste water having high turbidity or high suspended particulate matter. Organic coagulants have received considerable attention as replacement of inorganic coagulants (e.g., aluminum sulfate, polyaluminum chloride and ferric chloride). Although inorganic coagulants are less expensive, they are less efficient and result in a larger volume of sludge which needs further treatment.

One drawback to the use of coagulants or filter aids prior to the filtration of wastewater from oil and gas operations is that the wastewater, or produced water, from oil and gas wells typically contains high concentrations of total dissolved solids (TDS) or salts. For example, TDS levels in some produced water can be as high as 460,000 ppm (brine). Typical produced waters contain from about 5,000 ppm to about 250,000 ppm. As used herein, the unit ppm is equivalent to mg/L. The TDS content of any particular wastewater will vary greatly from one formation to the next, and one well to the next. Due to high TDS levels, the ability for conventional inorganic or organic polymers to remove solids suspended in water is impaired and it has proven challenging to provide for effective clarification and separation of this extremely salty, produced water. Similarly, the use of conventional filter aids to reduce fouling and increase throughput through low pressure filtration systems is impaired. Thus, it is an object of the present invention to provide a novel, more efficient and cost effective process for treating and filtering wastewater from oil and gas operations that is not affected by high TDS level, for example TDS levels greater than about 5,000 ppm and up to about 460,000 ppm.

An embodiments of the current invention provides for a method of reducing fouling, increasing flux, and increasing the efficiency during low pressure filtration of suspended particles from wastewater with high levels of total dissolved solids (TDS) by treating the wastewater with a tannin-based polymer, wherein the tannin-based polymer is a Mannich reaction product of an amine, an aldehyde and a tannin, and wherein the filtration is through microfiltration or ultrafiltration.

Processes that rely on porous/microporous membranes must be protected from fouling. As used herein, fouling is defined as a process where solute or particles deposit onto a membrane surface or into membrane pores in a way that degrades the membrane's performance. Membrane fouling causes a loss of water production or throughput (flux), affects the quality of the water treated, and increased trans-membrane pressure drop. Membrane fouling is typically caused by precipitation of inorganic salts, particulates of metal oxides, colloidal silt, and the accumulation or growth of microbiological organisms on the membrane surface. These fouling problems can lead to serious damage and necessitate more frequent replacement of membranes, and increases the operating costs of a treatment system.

Produced water pretreated with aminoalkylated tannin-based polymer exhibited effective coagulation of suspended particles despite high levels of TDS as compared to other cationic coagulants, including but not limited to other tannin-based polymers, and also exhibited reduced fouling, higher recoverability and increased flux when passed through a porous membrane. Additionally, aminoalkylated tannin-based polymers have a better environmental profile than traditional cationic organic coagulants.

In particular, tannin polymers comprised of a Mannich reaction product of an amine, an aldehyde, and tannin efficiently coagulated suspended particles from water containing TDS level as high as 200,000 ppm, and even higher, and showed enhanced filterability. One example of a tannin polymer comprised of a Mannich reaction product of an amine, an aldehyde, and tannin is sold by GE under the designation Klaraid PC2700. In contrast, and as shown in International Application No. PCT/US13/48153 filed on Jun. 27, 2013, other cationic coagulants including graft copolymer tannin and acryloyloxyethyltrimethylammonium chloride (AETAC), lignin amine, linear cationic copolymers and inorganic coagulants have failed to effectively remove suspended particles from high TDS water.

In one embodiment of the invention, environmentally benign coagulants made from naturally occurring tannins are used to pretreat and clarify oil-containing produced waters from oil and gas producing operations prior to passing the produced waters through low pressure filtration system. More specifically, a tannin-based polymer comprised of a Mannich reaction product of an amine, an aldehyde, and a tannin is employed.

In one aspect of the invention, prior to low pressure filtration, a Mannich-reaction, tannin-based polymer is added to the raw wastewater in a dosage range of from about 1 to about 200 ppm and more particularly between 3 and 60 ppm. The tannin-based coagulant is added in an amount effective to flocculate and precipitate out suspended solids, including but not limited to suspended inorganic and organic particles, suspended oil, suspended bacteria, suspended bioorganisms and any combination of the same, in order to reduce the turbidity and TSS content of the wastewater, or otherwise clarify the wastewater. For example, in some embodiments, the dosage comprises 1, 2, 3, 4, 5, 7, 10, 15, 20, 30, 40, 50, 60, 70, 80, 90, 100, 120, 125, 140, 150, 160, and 200 ppm of the tannin-based polymer, including any and all ranges and subranges therein (e.g., 1 to 200 ppm, 3 to 200 ppm, 10 to 200 ppm, 20 to 200 ppm, 1 to 150 ppm, 3 to 150 ppm, 1 to 100 ppm, 3 to 100 ppm, 1 to 60 ppm, 3 to 60 ppm, 5 to 60 ppm, 15 to 60 ppm, 1 to 40 ppm, 3 to 40 ppm, 5 to 40 ppm, 10 to 40 ppm, etc.). The water is then allowed to react for an effective residence time, e.g. 1 to 20 minutes. The treated produced water is then run through a porous membrane, including but not limited to a polymeric or ceramic membrane, or any other suitable membrane or media (e.g. mixed media filter) as is known in the art for low pressure filtration without affecting the overall concept of the invention.

In one embodiment, the high level TDS wastewater is produced water. The produced water can be wastewater from an oil and gas extraction. The levels of TDS will vary greatly from one formation to the next, and from one well to the next. For example, TDS content ranges can be characterized as 0 ppm to 9,999 ppm TDS content (fresh to brackish waters), 10,000 ppm to 99,999 ppm TDS content (low to high saline waters), 100,000 ppm to 460,000 ppm TDS content (low to high brine water).

The tannin-based coagulant is added to the high level TDS wastewater in any conventional manner. In one embodiment, the tannin-based polymer can be directly injected into untreated produced water. The tannin-based polymer can be added to the wastewater neat or in an aqueous solution either continuously or intermittently. In another embodiment, the tannin-based polymer is added to the wastewater in conventional wastewater treatment units, such as a clarifier. In other embodiments, the tannin-based polymer may be pre-blended with one or more other components, e.g., inorganic coagulants, anionic or cationic flocculants, or may be added separately. The tannin based polymer reduces fouling during filtration by acting as a fouling reducing filtering aid for wastewater with high TDS levels without requiring pretreatment methods to separate out coagulated solids prior to passing the wastewater through a ceramic membrane, or any other suitable membrane known in the art without affecting the overall concept of the invention.

In an exemplary embodiment, the tannin-based polymer is comprised of a Mannich Reaction product of an amine, an aldehyde, and a tannin. The aminoalkylation reaction between an aldehyde, amine and a nucleophilic compound, such as the phenolic compounds found in tannins, is known as the Mannich Reaction. The resulting aminoalkylated polymer possesses a higher molecular weight due to crosslinking of phenolic residues, and also possesses ampholytic character due to the presence of both cationic amines and anionic phenols on the polymers.

In accordance with this principle, tannin-containing extracts such as those from quebracho wood or wattle bark are polyphenolic and can be reacted with an aldehyde, particularly formaldehyde, and an amino compound such as monoethanolamine or ammonium salts such as ammonium chloride to form coagulants for water treatment. Exemplary tannin/amine/formaldehyde compounds include tannin/melamine/formaldehyde and tannin/monoethanolamine/formaldehyde polymers. Compounds according to the present convention are being sold by GE under the designation Klaraid PC 2700.

The tannin component for the aminoalkylated tannin polymer can be obtained from various wood and vegetation materials found throughout the world. Tannins are a large group of water-soluble complex organic compounds that naturally occur in leaves, twigs, barks, wood, and fruit of many plants and are generally obtained by extraction from plant matter. The composition and structure of tannins will vary depending on the source and method of extraction, but the generic empirical formula is represented by C₇₆H₅₂0O₄₆. Examples of barks from which tannins can be derived are wattle, mangrove, oak, eucalyptus, hemlock, pine, larch, and willow. Examples of woods are the quebracho, chestnut, oak, mimosa, and urunday. Examples of fruits are myrobalans, valonia, divi-diva, tara, and algarrobilla. Examples of leaves are sumac and gambier. Examples of roots are canaigre and palmetto.

These natural tannins can be categorized into the traditional “hydrolyzable” tannins and “condensed tannins” as disclosed by A. Pizzi in “Condensed Tannins for Adhesives”, Ind. Eng. Chem. Prod. Res. Dev. 1982, 21, 359-369. Condensed tannin extracts are those manufactured from the bark of the black wattle tree (or mimosa tannin of commerce), from the wood of the quebracho tree (Spanish: quebra hacha, axe-breaker,) from the bark of the hemlock tree, and from the bark of several commonly used pine species. The preparation of wattle and quebracho extracts is a well established industrial practice and they are freely available in considerable amounts.

Condensed tannin extracts, such as wattle and quebracho, are composed of approximately 70% polyphenolic tannins, 20% to 25% non-tannins, mainly simple sugars and polymeric carbohydrates (hydrocolloid gums), the latter of which constitute 3% to 6% of the extract and heavily contribute to extract viscosity, while the balance is accounted for by a low percentage of moisture.

In one aspect of the invention, the aminoalkylated tannin polymer is a Mannich reaction product of an amine, an aldehyde, and a tannin, as set forth in U.S. Pat. No. 4,558,080, incorporated by reference herein in its entirety. The '080 patent describes the production of a tannin-based flocculant using monoethanomlamine as the amino compound and formaldehyde as the aldehyde. As is stated in this patent, the amine, aldehyde, and tannin can be combined simultaneously, or in different orders. The components are reacted at an acidic pH wherein the molar ratio of amine to tannin present is from about 1.5:1 to 3.0:1.

While the aminoalkylated tannin polymer has been described above, it is understood that other tannin-based coagulants may be prepared by aqueous reaction of a tannin with an amino compound and aldehyde. Mimosa extract is shown to form a particular suitable flocculant, but both quebraco extract and wattle extract may be used from the standpoint of availability and proven suitability as flocculant-forming reactants. Other suitable aminoalkylated tannin polymers can also be used, by way of example only, the reaction product set forth in U.S. Pat. No. 5,659,002.

The second component is an aldehyde. Examples of some materials are formaldehyde which can be used in the form of a 37% active formaldehyde solution. This is also commercially available as formalin which is an aqueous solution of 37% formaldehyde which has been stabilized with 6-15% methanol. Other commercial grades of formaldehyde and its polymers could be used. Such commercial grades include 44, 45 and 50% low-methanol, formaldehyde, solutions of formaldehyde in methyl, propyl, n-butyl, and isobutyl alcohol, paraformaldehyde and trioxane.

Other aldehyde containing or generating reactants are organic chemical compounds which contain at least one aldehyde group therein including, without limitation, formaldehyde, acetaldehyde, propionaldehyde, glycolaldehyde, glyoxylic acid, or organic compounds having more than one aldehyde group in the compound, including, without limitation, glyoxal, paraformaldehyde and similar polyaldehydes. Other suitable aldehyde reactants include aldehyde generating agents, i.e. known organic compounds capable of forming an aldehyde group in situ, such as melamine-formaldehyde monomeric products and derivatives such as tri and hexa(methylol) melamine and the tri and hexa (C1-C3 alkoxymethyl) melamine. Such materials can be formed by known conventional methods. In an embodiment, the alkyl blocked derivatives are commercially available and stable to self-polymerization.

The third component for the reaction products is an amino compound such as ammonia or a primary or secondary amine or amide compound. Some materials include primary amines such as monoethanolamine, methylamine and ethylamine. The primary amines are utilized since they are the more reactive amines than secondary or tertiary amines. In reacting these three components it is necessary to do this under very controlled conditions and especially under a slight acidic condition where the pH is less than 7. Any acid can be used to obtain this condition i.e. muriatic acid and acetic acid.

In certain embodiments, the tannin-based coagulant may be conjointly applied with inorganic coagulants, or charged flocculants to treat the high TDS wastewater prior to filtration. For example, in certain embodiments, a cationic flocculant can be added in a dosage range of 0.05 ppm to 1.0 ppm, more particularly 0.1 to 0.5 ppm, to further increase the flux rate. In exemplary embodiments, the cationic flocculant is allowed to react for about 1 to 20 minutes. Subsequent to the addition of the cationic flocculant, in another exemplary embodiment, an anion flocculant may be added in a dosage range of about 0.05 ppm 1.0 ppm, more particularly 0.1 to 0.5 ppm. However, because high molecular weight flocculants may increase the risk of membrane fouling, the dosage needs to be carefully adjusted and monitored in order to maintain membrane performance. The tannin-based polymer and optional flocculants can be added during treatment either separately, or together, as a composition. Exemplary cationic flocculants include the cationic acrylamide/quaternary ammonium salt copolymers, acrylamide/dialkylaminoalkyl (meth)acrylamide copolymer, acrylamide/dialkylaminoalkyl (meth)acrylate copolymer, polyepichlorohydrin (EPI)/dimethylamine (DMA), acrylamide/allyl trialkyl ammonium copolymer, or an acrylamide diallyldialkyl ammonium copolymer. Exemplary anionic flocculants comprise primarily acrylamide copolymers such as acrylamide/(meth)acrylic acid copolymers, acrylamide alkylacrylate copolymer, acrylamide/maleic acid, acrylamide/maleic anhydride copolymers, acrylamide/styrene sulfonic acid copolymers, and acrylamide/2-acrylamido-2-methyl propane sulfonic acid (AMPS) copolymers. Additionally, acrylic acid homopolymers and salt forms, especially Na salts may be used along with acrylic acid based copolymers such as acrylic acid/AMPS copolymers. Specifically, the acrylic acid (AA)/acrylamide copolymers wherein the AA is present in an amount of about 20-50 molar %. If an inorganic coagulant is used, it is selected from the group consisting of Ca, Mg, Al and Fe, and combinations thereof, such as ferric chloride, aluminum chloride, polyaluminum chloride, and can be added together with the tannin-based coagulant.

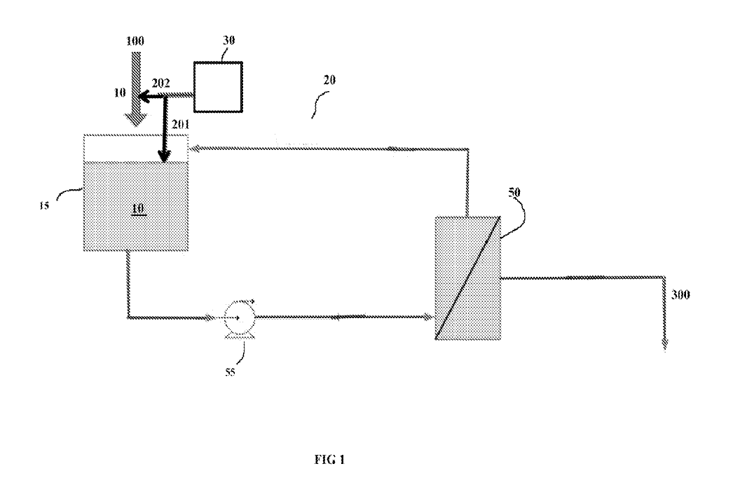

In operation, and as shown in FIG. 1, influent wastewater 10 (e.g. produced water or other wastewater with high TDS levels) will be transferred, or drawn, from a source 100 to a treatment system 20, wherein the treatment system 20 comprises one or more storage (or holding) tanks, ponds, or vessels 15. In accordance with embodiments of the invention, an effective amount of a tannin polymer amine 30 will be added to the influent water 10, either before the wastewater is transferred into the storage (or holding) tanks, ponds, or vessels 15 (see 202), and/or once the influent water 10 is contained within the storage (or holding) tanks, ponds, or vessels 15 (see 201). After being treated with an effective amount of tannin-based polymer 30 for an effective residence time within the tank, pond or vessel 15, a stream of the treated wastewater will be transferred to an appropriate filtration system or device 50 via pump 55, wherein the flocculated solid particles are separated and removed from the wastewater stream via low pressure UF or MF filtration methods known in the art prior to discharge into clearwell 300 from the system (or return to tanks, ponds, or vessel 15 for further treatment).

For example, in one embodiment, the solid phase is separated from the wastewater by low pressure microfiltration (MF). As known in the art, microfiltration is performed using porous membranes with a pore size of 0.1-3 μm, although some microfiltration membranes have a pore size up to 10 μm. Typically, MF is used for turbidity reduction and removal of suspended solids. It can also be used to remove bacteria. The filter medium used for MF will physically retain (and therefore remove from the treated wastewater) any particles with a particle diameter of 0.05 and 5.0 μm, while at the same time the treated wastewater is allowed to pass through the membrane. The porous membrane used will depend on the characteristics of the wastewater to be treated and may be selected from membranes known in the art, such polymeric membranes, e.g. expanded polytetrafluoroethylene/polytetrafluoroethylene (ePTFE/PTFE), inorganic membranes, ceramic membranes, or organic membranes. For example, in embodiments disclosed herein, an ePTFE membrane with 1.5 μm pore size on a PTFE felt support was used. In exemplary embodiments, the trans-membrane pressure is in the range of 1 to 30 psi (for example, microfiltration). In other exemplary embodiments, the trans-membrane pressure is in the range of 5 to 60 psi (for example, ultrafiltration). The configuration in FIG. 1 shows Pump 55 providing pressure driven ahead of the filtration unit. In alternate configurations, Pump 55 could provide a vacuum driven flow, or any other suitable pumping arrangement known in the art and used in conventional microfiltration systems.

In certain embodiments, the solid phase is separated from the wastewater by low pressure ultrafiltration (UF). Typically, ultrafiltration membranes will remove particles with diameters of 0.01-0.1 μm from fluids and, therefore, is used to remove some viruses, color, odor, and some colloidal natural organic matter. Some ultrafiltration membranes are capable of removing particles with diameters <0.01 μm (e.g. 0.001 to 0.1 μm) The porous membrane used for ultrafiltration will depend on the characteristics of the wastewater to be treated and may be selected from membranes known in the art, such polymeric membranes, inorganic membranes, ceramic membranes, or organic membranes. In still other embodiments, single, dual and/or mixed media filters (e.g. gravity filters, sediment, activated carbon, etc) are used.

In the embodiments described herein, the application of a tannin-based polymer prior to low pressure filtration of high TDS water reduces fouling and avoids the need for additional conventional pretreatment methods, e.g. removal of solids/particles, before solid removal by filtration. For example, using the techniques described herein, there is no need to separate out coagulated solids, for example using granular media filtration, prior to filtration by UF or MF. Instead, the coagulated solids can remain in the produced water to be treated and filtered, and one will still observe an increase in flux, reduced fouling and an increase in membrane recoverability. This allows for treatment of produced water that only requires microfiltration (and/or ultrafiltration) equipment, does not require any pretreatment other than with the modified tannin, reduces the footprint and simplifies the treatment of produced water or other wastewater with high TDS levels.

One of ordinary skill in the art will recognize that the factors influencing which type of membrane or low pressure filtration system to use will vary and depend on the source of the wastewater, characteristics of the raw wastewater, and how the treated wastewater is intended to be reused, if at all, as well as cost, flux/membrane recovery, rejection, and other pretreatment requirements (if any). Factors influencing performance of the selected filtration system will also include raw wastewater characteristics, what pressure is used across the membrane to compress and push the treated water through the membrane, temperature, and how well the filtration system (membrane) is maintained. Other factors include fluid viscosity and chemical interactions between the membrane and the particles in the solution.

In other exemplary embodiments, although not necessary, low pressure filtration in accordance with this invention can be applied conjointly with other conventional oil and water separating and/or removal units such as flotation devices, sedimentation devices, settling tanks, centrifuges, clarifiers, hydrocyclones, enhanced gravity separation devices, microscreens, and combination thereof.

In operation, when using the tannin-Mannich based polymer, the amount added to the system to be treated should be an amount sufficient for its intended purpose. For the most part, this amount will vary depending upon the particular system for which treatment is desired and the measured TDS of the wastewater, and also can be influenced by such factors as pH, temperature, water quantity, geology of formation, location and type of contaminants present in the system. In other words, the amount of modified tannin-based polymer required for effective filtration is dependent upon the treatment objectives as well as on the quality of the water to be treated and the nature of the solids suspended therein. The tannin based polymer may be added continuously or intermittently, depending on the filtration system being used and wastewater to be treated.

Although tannin containing polymers are effective at a wide range of pHs and should prove effective at the pH of any system, under certain conditions the pH of the system can be important for efficient floc formation and the optimum pH for floc formation varies from water to water. Thus, pH adjustment may be an effective treatment step. For example, in one embodiment, no pH adjustment is made to the wastewater. However, depending on the characteristics of the produced water and the system requirements, in certain embodiments the pH of the wastewater may be adjusted to improve and filterability characteristics. The pH adjustment can be made either before or after the tannin-based coagulant is added to improve the performance of the coagulant or flocculants used in the treatment. For example, in one embodiment, the pH of the wastewater is from about 2 to about 11. In another embodiment, the pH is adjusted to an acidic pH range. In another embodiment, the pH is adjusted to an alkaline pH range. In another embodiment, the pH is adjusted to a neutral pH range. In yet another embodiment, the pH of the wastewater is adjusted to a pH value in a range from about 4 to about 7.5. In certain embodiments, the coagulants and flocculants as described above are used, but pH adjustment is made to the water during one or both of the following steps: the step before addition of the tannin-based coagulant or after addition of the tannin-based coagulant.

Although the description above discusses reducing fouling, increased efficiency, increased membrane recoverability, and increased effectiveness of a filtration system for produced water from traditional oil and gas operations, the method of treating and filtering high TDS wastewater described herein could also be applied to other resource extraction operations, such as hydraulic fracturing, mining, and oil and gas refining or production. For example, hydraulic fracturing processes produce millions of gallons of frac-water. Once the fracturing is complete, contaminated frac water will contain oily residue that must be separated prior to discharge of the water in an environmentally acceptable manner. The methods disclosed herein could be used for effective filtration of frac waters from oil and gas producing operations that contains high levels of TDS in the same manner as that described herein for other produced water. Similarly, the methods disclosed herein can be applied onsite (for example, at a hydraulic fracturing site), rather than at a separate treatment plant, by one with skill in the art by incorporating the methods and systems described herein in-line with existing on-site operations and systems.

In accordance with one aspect of the invention, no or substantially no antifoaming agents are needed. Typically, aminoalkylated tannin polymers have an environmentally friendly profile, i.e. minimal toxicity and biodegradable, so that it results in minimal harmful effect to the environment after discharge.

### EXAMPLES

Laboratory jar test studies were conducted to evaluate and demonstrate the coagulation performance of tannin-based polymers versus a variety of other coagulants for removing suspended solids from produced water with high TDS levels. Water clarification tests were performed on samples with known Total Dissolved solids (TDS), Total Organic Carbon (TOC), and Total Suspended Solids (TSS). The test procedure consisted of: adjusting pH value to 7 with 1N NaOH aqueous solution, adding the polymer treatment to the test sample at various dosages, mixing the treated sample at a speed of 100 rpm for 1 min and then 30 rpm for 5 min, allowing the solids formed in the water to settle for 5 min, and finally measuring the residual turbidity of the supernatant water produced by each treatment. Turbidities of untreated and treated water samples were determined using a Hach turbidimeter following Standard Methods protocols 2130B in order to approximate the TSS in each sample and evaluate the coagulation performance of the polymer.

During the filtration test, testing produced water was mixed at 300-500 rpm. After addition of polymers, the water continued to be stirred at 300-500 rpm for 1 min, then at 50 rpm for 20 min before being poured into a pressure tank for the filtration test. The tank pressure was kept at 6 psi. The testing membrane was an ePTFE membrane with 1.5 μm pore size on a PTFE felt support, which was pre-wetted with isopropanol. The filtration test began with an initial flux measurement (A) using about 1-2 L deionized water. Then the chemically treated produced water was filtered and the flow rate was measured gravimetrically over time. After filtration of the treated water, the membrane was washed by gently removing cake layer from the membrane surface using deionized water. The filtration test ended with a final flux measurement (J_{f}) using about 1-2 L deionized water. The flux, or membrane, recovery percentage was defined as the percent recovery of pure water flux after exposure of the membrane to the treated water (J_{f}/Ji*100%).

The following serve as examples without limitation of the applicability to other high TDS wastewater or microfiltration. As demonstrated by the following, tannin-amine polymers exhibit efficient solid removal, reduction of membrane fouling, and increased flux during microfiltration of water containing high TDS level, while the ability for conventional inorganic or organic polymers to remove solids suspended in water is impaired due to high TDS.

### Example 1

250 ml of a model produced water containing varied levels of TDS and TOC was prepared and continuously stirred. The levels of TDS in the samples were between 0 to 200,000 ppm, and the TOC varied between 0-500 ppm. In each sample, the TSS was measured to be about 2000 ppm. The pH of the samples was measured to be about 7 pH units. Varied dosages between 2-200 ppm of a Aminoalkylated tannin (PC2700, available from GE) was added to the samples. The stirring for each sample was stopped after 5-10 minutes slow mixing and the solids were allowed to settle for 5 min. Table 1 contains the efficacy test results for the tannin-based polymer on a model produced water. In each example, turbidity measurement is used as an estimate of the total suspended solids (TSS) concentration (mg/L).

TABLE 1
Turbidity (NTU) testing for PC2700 with water containing varied amount of TDS (ppm = mg/L)

| testing water | | | | | | | | | | | | | | | | | |
|---|---|---|---|---|---|---|---|---|---|---|---|---|---|---|---|---|---|
| TSS | TDS | TOC | 0 | 2 | 5 | 10 | 20 | 30 | 40 | 50 | 60 | 70 | 80 | 100 | 140 | 180 | 200 |
| (ppm) | (ppm) | (ppm) | ppm | ppm | ppm | ppm | ppm | ppm | ppm | ppm | ppm | ppm | ppm | ppm | ppm | ppm | ppm |
| 2000 | 0 | 0 | 1769 | | | | | | 143 | 15.8 | 11.6 | 9.2 | 14.2 | | | | |
| 2000 | 5000 | 0 | 193 | | 30.3 | 23 | | | 8.6 | | 7.04 | | 7.34 | 11.3 | 19.5 | | |
| 2000 | 5000 | 500 | 149.3 | 13.3 | 6.42 | 6.63 | 6.81 | 6.75 | 36.9 | | 101.1 | | 75.6 | 87.8 | | | |
| 1000 | 10500 | 250 | 361 | | 19.9 | 12.9 | 8.85 | 5.82 | 3.51 | | 4.13 | | | 6.16 | | | |
| 2000 | 200000 | 0 | 834 | | | 278 | | 106 | | | 16.6 | | 10.1 | 9.23 | 6.14 | 6.03 | 5.49 |
| 2000 | 200000 | 500 | 704 | | | | | 90 | 71 | | 25 | | 20.8 | 16.7 | 16.2 | | 11.9 |

Reported turbidities are the lowest turbidity (NTU) measured for each active dosage

### Example 2

250 ml samples of a model produced water containing varied levels of TDS and TOC were prepared and continuously stirred. The levels of TDS in the samples were between 0-200,000 ppm, and the TOC varied between 0-500 ppm. In each sample, the TSS was measured to be about 2000 ppm. The pH of the samples was measured to be about 7 pH units. Varied dosages between 0-40 ppm of tannin/AETAC or between 0-20 ppm of PDADMAC were added to the samples. The stirring for each sample was stopped after 5-10 minutes slow mixing and the solids were allowed to settle for 5 min. Table 2A contains the efficacy test results for PDADMAC on a model produced water, and Table 2B contains the efficacy test results for tannin/AETAC on a model produced water containing varied TDS and TOC levels.

TABLE 2A
Turbidity (NTU) testing for PDADMAC with water containing varied amount of TDS (ppm = mg/L)

| testing water | | | | | | | | | | | | | |
|---|---|---|---|---|---|---|---|---|---|---|---|---|---|
| TSS | TDS | TOC | 0 | 0.1 | 0.2 | 0.5 | 1 | 2 | 5 | 8 | 10 | 20 | 40 |
| (ppm) | (ppm) | (ppm) | ppm | ppm | ppm | ppm | Ppm | Ppm | ppm | ppm | ppm | ppm | ppm |
| 2000 | 0 | 0 | 1769 | | | | | 264 | 50 | 192 | 672 | | |
| 2000 | 5000 | 0 | 193 | | | | | 198 | 190 | | 462 | 1005 | |
| 2000 | 5000 | 500 | 149.3 | | | 42.8 | 85.1 | 109.1 | | | | | |
| 2000 | 200000 | 0 | 834 | 590 | 560 | | 498 | | 691 | | | | |
| 2000 | 200000 | 500 | 704 | | | | 584 | | 856 | | | | |

Reported turbidities are the lowest turbidity (NTU) measured for each active dosage.

TABLE 2B
Turbidity (NTU) testing for tannin/AETAC with water containing varied amount of TDS (ppm = mg/L)

| testing water | | | | | | | | | | | | | | | |
|---|---|---|---|---|---|---|---|---|---|---|---|---|---|---|---|
| TSS | TDS | TOC | 0 | 0.1 | 0.2 | 0.4 | 0.5 | 1 | 2 | 5 | 8 | 10 | 16 | 20 | 40 |
| (ppm) | (ppm) | (ppm) | Ppm | ppm | ppm | ppm | ppm | Ppm | Ppm | ppm | ppm | ppm | ppm | ppm | ppm |
| 2000 | 0 | 0 | 176.9 | | | | | | | 286 | 23.6 | 18.0 | 36.9 | 115 | 1610 |
| 2000 | 5000 | 0 | 193 | | | | | | 97.3 | 260 | | 237 | | 301 | |
| 2000 | 5000 | 500 | 149.3 | | | | 48.0 | 36.1 | 76.1 | | | | | | |
| 2000 | 200000 | 0 | 834 | 774 | 421 | 150.8 | | 226 | | 668 | | | | | |
| 2000 | 200000 | 500 | 704 | | | | | 232 | | 493 | | | | | |

Reported turbidities are the lowest turbidity (NTU) measured for each active dosage.

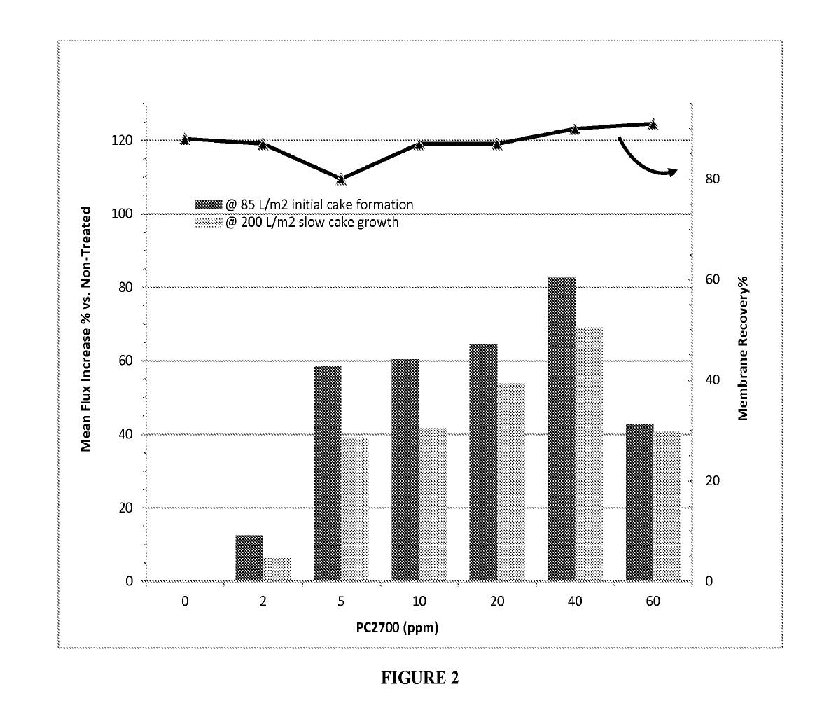

Filterability studies were conducted using PC2700 and a high TDS model produced water (TSS=1000 ppm; TOC=250 ppm; TDS=102500 ppm, pH=7). The filtration was performed using an ePTFE membrane with 1.5 μm pore size on a PTFE felt support under 6 psi pressure at room temperature. The results are summarized in Table 3 and FIG. 2. The mean flux rate was increased by up to about 200% with addition of coagulants and/or flocculants. The filtration improvement is attributed to an increase in cake porosity built on the membrane surface which is correlated to the increase of floc size. In addition, membrane fouling caused by pore plugging is reduced since floc size distribution shifts to large size. Moreover, the membranes maintained high recovery even at high dosage, indicating that the aminoalylated tannin polymer was compatible with the membrane.

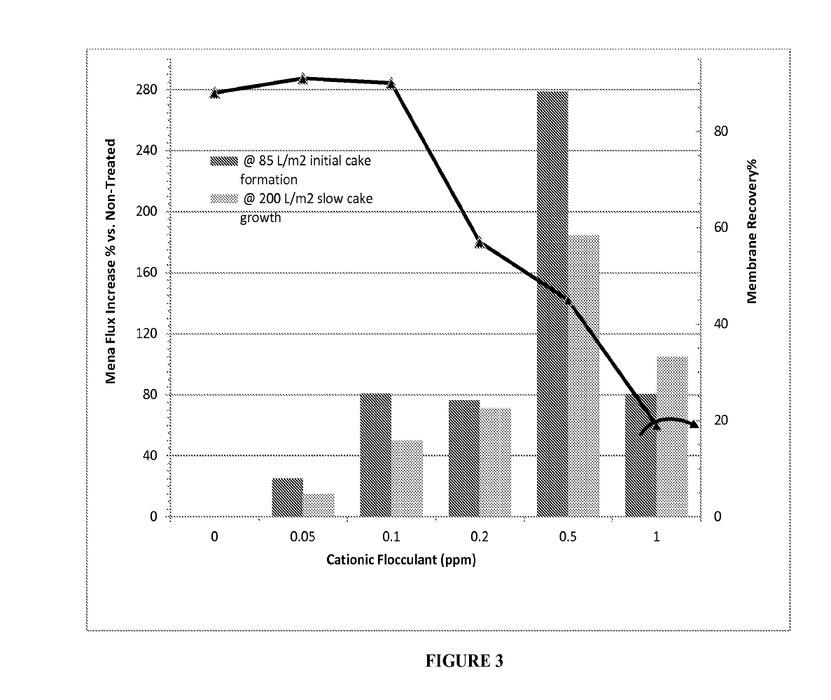

The filterability of high TDS model produced water (TSS=1000 ppm; TOC=250 ppm; TDS=102500 ppm) treated with high molecular weight cationic flocculant was studied. The filtration was performed using an ePTFE membrane with 1.5 μm pore size on a PTFE felt support. As shown in Table 3 and FIG. 3, high molecular weight flocculant also improved membrane filtration. Specifically, the addition of 0.5 ppm cationic flocculant nearly tripled the flux rate. However, unlike the PC2700 treatment, the membrane recovery dropped to only 45%. High TDS water treated with 0.1 ppm high molecular weight anionic flocculant gave only 17% membrane recovery. Co-feeding cationic coagulant with flocculant did not improve membrane recoveries. These results indicate that high molecular weight flocculants have a high risk of membrane fouling and, therefore, their dosage needs to be carefully adjusted to maintain membrane performance. Similar considerations are not required of the PC2700 coagulant.

TABLE 3
Filtration Performance with Aids of Coagulants and Flocculants

| | mean | flux | recovery | average |
|---|---|---|---|---|
| | flux | increase | percentage | particle size |
| | (GFD) | (%) | (%) | (μm) |
| no chemicals | 464^{b} | 0 | 88 | 14.4 |
| (water 1) | | | | |
| PC2700 | | | | |
| 2 ppm | 494^{b} | 6.5 | 87 | 19.6 |
| 5 ppm | 645^{b} | 39.2 | 80 | 21.3 |
| 10 ppm | 658^{b} | 41.8 | 87 | 24.8 |
| 20 ppm | 714^{b} | 54.0 | 87 | 27.8 |
| 40 ppm | 785^{b} | 69.3 | 90 | 34.8 |
| 60 ppm | 652^{b} | 40.7 | 91 | 46.0 |
| cationic flocculant | | | | |
| 0.05 ppm | 532^{b} | 14.8 | 91 | 17.2 |
| 0.1 ppm | 695^{b} | 49.9 | 90 | 26.6 |
| 0.2 ppm | 794^{b} | 71.3 | 57 | 35.4 |
| 0.5 ppm | 1319^{b} | 184.4 | 45 | 56.4 |
| 1.0 ppm | 951^{b} | 105.2 | 19 | 76.9 |
| no chemicals | 657^{a} | 0 | 88 | |
| (water 2) | | | | |
| anionic flocculant | 815^{a} | 24.1 | 17 | |
| 0.1 ppm | | | | |
| cationic flocculant | 909^{a} | 38.4 | 85 | |
| 0.1 ppm | | | | |
| no chemicals | 416^{b} | 0 | 84 | |
| (water 3) | | | | |
| PAC 10 ppm + | 1221^{b} | 193.9 | 49 | |
| CF 0.5 ppm | | | | |

^{a}Mean flux at 400 L/m²
^{b}Mean flux at 200 L/m².
PAC: polyaluminum chloride.
Model produced waters 1-3 were made in different batches, but had same composition: TSS = 1000 ppm, TDS = 102500 ppm, TOC = 250 ppm, pH = 7. Filtration membrane: ePTFE/PTFE with 1.5 μm pore size. Pressure: 6 Psi. Room temperature.

Table 4 shows the filtration results of a field-sourced produced water from a tight-gas operation. Addition of PC2700 increased flux rate by about 40% to about 60%. As shown, the membrane recovery increased from about 65% to about 86% with 60 ppm PC2700 due to reduction of pore plugging.

TABLE 4
Filtration of field-sourced produced water

| | | flux | | |
|---|---|---|---|---|
| | mean | increase % | recovery | |
| | flux | (vs. no | percentage % | average particle |
| | (GFD) | chemicals) | (gentle wash) | size (micron) |
| no chemicals | 30 | 0 | 65 | 11.6 |
| PC2700 30 ppm | 41 | 36.7 | 80 | 32.9 |
| PC2700 60 ppm | 47 | 56.7 | 86 | 37.6 |

^{a}Mean flux at 300 L/m². Field sourced water: TSS = 144 ppm, TDS = 8120 ppm, TOC = 345 ppm, pH = 8.0. Filtration membrane: ePTFE/PTFE with 1.5 μm pore size. Pressure: 6 Psi. Room temperature.

Table 5 shows the filtration results of field-sourced produced water containing 217,000 ppm TDS. Fine particulates in this produced water led to irreversible fouling due to pore plugging. Addition of 3 ppm PC2700 increased membrane recovery from about 18% to about 85% because the average particle size increased by 100%.

TABLE 5
Filtration of CHK Polly Produced Water

| | Recovery | |
|---|---|---|
| | percentage % | average particle |
| | (gentle wash) | size (micron) |
| no chemicals | 18 | 9.9 |
| PC2700 3 ppm | 85 | 19.0 |

^{a}Mean flux at 300 L/m². Field sourced water: TSS <100 ppm, TDS = 217,000 ppm, TOC <50 ppm, pH = 7.5. Filtration membrane: ePTFE/PTFE with 1.5 μm pore size. Pressure: 6 Psi. Room temperature.

From the above results, it will be appreciated that the use of aminoalkylated polymers in high TDS water demonstrates a substantial increase in flux rate and membrane recovery that is both unexpected and unanticipated based on the performance of other common cationic coagulants.

While the tannin-based polymer has been described above, it is understood that other aminoalkylated polymers may be prepared by aqueous reaction of a tannin with an amino compound and an aldehyde and used as a filter aid for low pressure filtration systems in accordance with various aspects described herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While this invention has been described in conjunction with the specific embodiments described above, it is evident that many alternatives, combinations, modifications and variations are apparent to those skilled in the art. Accordingly, the embodiments of this invention, as set forth above are intended to be illustrative only, and not in a limiting sense. Various changes can be made without departing from the spirit and scope of this invention. Therefore, the technical scope of the present invention encompasses not only those embodiments described above, but also all that fall within the scope of the appended claims.

This written description uses examples to disclose the invention, including the best mode, and also to enable any person skilled in the art to practice the invention, including making and using any devices or systems and performing any incorporated processes. The patentable scope of the invention is defined by the claims, and may include other examples that occur to those skilled in the art. These other examples are intended to be within the scope of the claims if they have structural elements that do not differ from the literal language of the claims, or if they include equivalent structural elements with insubstantial differences from the literal language of the claims.

What is claimed is:

1. A method for reducing the fouling and increasing the flux of low pressure filtration systems for wastewater containing suspended solids, the wastewater having a high total dissolved solids (TDS) concentration, comprising:
providing wastewater having a TDS content greater than about 5,000 ppm;
treating the wastewater with an effective amount of at least one modified tannin effective to flocculate solids suspended in the wastewater, wherein the modified tannin is produced by reacting a condensed tannin with an amino compound and an aldehyde;
producing flocculated solids and treated water with reduced turbidity; and
passing the treated water through a low pressure filtration medium to remove flocculated solids suspended from the treated water.

2. The method of claim 1, wherein the low pressure filtration medium comprises a porous membrane.

3. The method of claim 2, wherein the porous membrane has a pore size of about 0.1 to about 3 μm.

4. The method of claim 2, wherein the porous membrane has a pore size of about 0.001 to about 0.1 μm.

5. The method of claim 1, wherein the low pressure filtration medium is selected from the group comprising a mixed media filter, a microfiltration filter or an ultrafiltration filter.

6. A method for reducing the fouling of low pressure filtration systems comprising:
drawing influent wastewater from a source, wherein the wastewater contains suspended solids and has a total dissolved solids content greater than about 5,000 ppm;
placing the influent wastewater into a holding tank, pond, or vessel;
adding an effective amount of a tannin amine polymer to the influent wastewater to produce treated wastewater and flocculated solids; and
directing a stream of treated wastewater from the holding tank, pond, or vessel to a low pressure filtration system.

7. The method according to claim 6 wherein the filtration system comprises a microfiltration porous membrane.

8. The method according to claim 6 wherein the filtration system comprises an ultrafiltration porous membrane.

9. The method according to claim 6 wherein the tannin amine polymer is added to the influent wastewater either prior to, substantially contemporaneous with, or subsequent to placement of the wastewater in the holding tank, pond, or vessel.

10. The method according to claim 1 wherein the wastewater has a TDS content of about 5,000 ppm to about 460,000 ppm, more preferably 10,000 ppm to about 250,000 ppm, and even more preferably 50,000 ppm to about 200,000 ppm.

11. The method according to claim 1 wherein the modified tannin is a tannin amine polymer.

12. The method according to claim 1 wherein the modified tannin comprises a Mannich reaction product of a tannin, a primary amine and an aldehyde.

13. The method according to claim 1 wherein the modified tannin comprises a reaction product of tannin, monoethanolamine and formaldehyde.

14. The method according to claim 1 wherein the modified tannin comprises a reaction product of tannin, melamine and formaldehyde.

15. The method according to claim 1 wherein the modified tannin is produced by reacting a tannin extracted from quebracho wood or wattle bark with formaldehyde and an amino compound selected from a group consisting of monethanolamine, methylamine and ammonium chloride.

16. The method according to claim 1 wherein production of the modified tannin comprises
forming an aqueous reaction mixture of the tannin, the amino compound and formaldehyde under slightly acidic conditions where the pH is less than 7 and where the molar ratio of the primary amine from the amino compound to the tannin repeating unit is from about 1.5:1 to 3.0:1;
heating the reaction mixture at a temperature of from about 150-200° F. until the reaction product forms which has an intermediate viscosity within the range of the system key intermediate viscosity range, the system key intermediate viscosity range being determined for each reactant system as the narrow intermediate viscosity range which permits the resulting product to have a long shelf-life, the system key intermediate viscosity range being within the range of form about 2-100 cps when measured at 180° F. on a Brookfield LVT viscometer,
terminating the reaction when the intermediate viscosity range is about 2-100 cps when measured at 180° F. on a Brookfield LVT viscometer; and
adjusting the solids content of the liquid to about 20 to 60 percent by weight and adjusting the pH to a value of less than 3.0.

17. The method according to claim 1 wherein the effective amount of tannin containing polymer is from about 1 ppm to about 200 ppm.

18. The method according to claim 1 further comprising adding to the wastewater an effective amount of an inorganic coagulant, a cationic flocculant or anionic flocculant.

19. The method according to claim 1 further comprising adjusting the pH of the wastewater to optimize the step of producing flocculated solids.

20. The method according to claim 1 wherein the suspended solids are selected from the group consisting of suspended inorganic and organic particles, suspended oil, suspended bacteria, suspended bioorganisms and a combination of the same.

21. The method according to claim 1 wherein the wastewater comprises produced water from an oil and gas operation, frac water from a hydraulic fracturing operation, brine, or any oil-containing water associated with oil and gas extraction, recovery, production or generation processes.

22. The method according to claim 2 wherein a trans-membrane pressure across the porous membrane is in the range of 1 to 60 psi.

23. The method according to claim 2 wherein the membrane recovery is about 15 to about 67 percent higher than the membrane recovery observed prior to treatment with the tannin containing polymer.

24. The method according to claim 2 wherein the flux rate across the membrane is about 36 percent to about 200 percent higher than the flux rate observed prior to treatment with the tannin containing polymer.

25. The method according to claim 1 wherein the turbidity of the wastewater treated decreases to levels of from about 1 percent to about 15 percent of initial values.
